(19) United States
(12) Patent Application Publication
(10) Pub. No.: US 2010/0245568 A1
(43) Pub. Date: Sep. 30, 2010

(54) Systems and Methods for Surveillance and Traffic Monitoring (Claim Set II)

(75) Inventors: Charles K. Wike, JR., Sugar Hill, GA (US); Jeremy D. Hood, Canton, GA (US); Donald R. Wyman, Flowery Branch, GA (US); Robert P. Burke, Duluth, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Lasercraft, Inc.

(21) Appl. No.: 12/413,858

(22) Filed: Mar. 30, 2009

(51) Int. Cl. H04N 7/18

(52) U.S. Cl. 348/143; 348/149; 348/E07.085

(57) ABSTRACT

System, methods, and computer program products are provided for surveillance, traffic monitoring, and red light enforcement. In one embodiment, the system may monitor zones of interest; capture, time stamp, and store images of the zones of interest; determine that an event has occurred within one of the zones of interest; and request the stored images of the zone of interest during the time the event occurred.

### BACKGROUND OF THE INVENTION

It is estimated that as many as 200,000 traffic accidents are caused annually because of red-light running. As a result of these traffic accidents, many pedestrians and vehicle occupants are injured or killed. In an effort to curb red-light running and promote better driving, some localities have implemented automated traffic enforcement systems, such as automated red light enforcement systems. Current red light enforcement systems are predictive in nature. That is, these systems (1) predict if a vehicle is going to run a red light (typically determining how fast a vehicle is traveling as it approaches an intersection) and (2) take images of vehicle running the red light (referred to as a “runner”). Unfortunately, there are a variety of shortcomings with the predictive red light enforcement systems. For example, predictive red light enforcement systems (a) are often incorrect (e.g., a driver may actually stop even though he is approaching an intersection at a high speed), (b) are susceptible to stop-and-go runners (e.g., drivers who first stop at the red light and then run it), and (c) are susceptible to slow runners (e.g., drivers who approach the intersection slowly and run the red light without stopping). Thus, there is a need for a traffic enforcement or monitoring system that includes non-predictive red light enforcement.

### BRIEF SUMMARY OF VARIOUS EMBODIMENTS OF THE INVENTION

In general, according to various embodiments of the present invention, methods, apparatus, systems, and computer program products are provided for enhanced surveillance, traffic monitoring, and red light enforcement. Various embodiments of the invention solve one or more of the above-noted problems of previous systems.

In accordance with one aspect, a system is provided. In one embodiment, the system comprises a signal monitoring computing device with one or more processors configured to monitor the states of a traffic signal, wherein a first state indicates that the traffic signal is displaying a green signal and a second state indicates that the traffic signal is displaying a red signal. The one or more processors of the signal monitoring computing device are also configured to generate and transmit a red signal message indicating that the traffic signal has changed to the second state of the traffic signal. In one embodiment, the system also includes a first imaging device configured to capture a first set of images of a first surveillance zone during the first and second states of the traffic signal. The first imaging device is also configured to time stamp the first set of captured images respectively in accordance with a corresponding network time and store the first set of captured images in a temporary memory storage area of the first imaging device. The system also includes a trigger monitoring computing device comprising one or more processors configured to determine when a vehicle enters a violation zone, wherein the violation zone is within the first surveillance zone. The one or more processors of the trigger monitoring computing device are also configured to generate and transmit an enter message indicating (a) that a vehicle has entered the violation zone and (b) the time the vehicle entered the violation zone in accordance with the corresponding network time. The one or more processors of the trigger monitoring computing device are also configured to determine when the vehicle exits the violation zone and generate and transmit an exit message indicating (a) that the vehicle has exited the violation zone and (b) the time the vehicle exited the violation zone in accordance with the corresponding network time. The system also comprises a control computing device comprising one or more memory storage areas and one or more processors. In one embodiment, the one or more processors of the control computing device are configured to request a subset of the first set of images of the first surveillance zone from the temporary memory storage area of the first imaging device that were captured during the first and second states of the traffic signal.

In accordance with another aspect, another system is provided. In one embodiment, the system comprises a signal monitoring computing device comprising one or more processors configured to monitor the states of a traffic signal, wherein a first state indicates that the traffic signal is displaying a green signal and a second state indicates that the traffic signal is displaying a red signal. The one or more processors of the signal monitoring computing device are also configured to generate and transmit a red signal message indicating that the traffic signal has changed to the second state of the traffic signal. The system also comprises a first imaging device configured to capture a first set of images of a first surveillance zone during the first and second states of the traffic signal. The first imaging device is also configured to time stamp the first set of captured images respectively in accordance with a corresponding network time and store the first set of captured images in a temporary memory storage area of the first imaging device. The system also comprises a control computing device comprising one or more memory storage areas and one or more processors. In one embodiment, the one or more processors of the control computing device are configured to determine when a vehicle enters a violation zone in accordance with the corresponding network time, wherein the violation zone is within the first surveillance zone. The one or more processors of the control computing device are also configured to determine when the vehicle exits the violation zone in accordance with the corresponding network time and request a subset of the first set of images of the first surveillance zone from the temporary memory storage area of the first imaging device that were captured during the first and second states of the traffic signal.

In accordance with another aspect, another system is provided. In a particular embodiment, the system comprises a first imaging device configured to capture a first set of images of a first surveillance zone and time stamp the first set of captured images respectively in accordance with a corresponding network time. This first imaging device is also configured to store the first set of captured images in a temporary memory storage area of the first imaging device. The system also comprises a control computing device comprising one or more memory storage areas and one or more processors. In one embodiment, the one or more processors of the control computing device are configured to (a) determine when an event occurs proximate the first surveillance zone in accordance with the corresponding network time, (b) request a subset of the first set of images of the first surveillance zone from the temporary memory storage area of the first imaging device, and (c) store the first set of images in the one or more memory storage areas of the control computing device.

In accordance with still another aspect, another system is provided. In one embodiment, the system comprises a first imaging device configured to capture a first set of images of a first surveillance zone and time stamp the first set of captured images respectively in accordance with a corresponding network time. The first imaging device is also configured to store the first set of captured images in a temporary memory storage area of the first imaging device. The system also comprises an event monitoring computing device comprising one or more processors configured to (a) determine when an event occurs proximate the first surveillance zone; and generate and (b) transmit an event message indicating (i) that an event has occurred proximate the first surveillance zone and (ii) the time the event occurred in accordance with the corresponding network time. The system also comprises a control computing device comprising one or more memory storage areas and one or more processors configured to (a) request a subset of the first set of images of the first surveillance zone from the temporary memory storage area of the first imaging device and (b) store the first set of images in the one or more memory storage areas of the control computing device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an overview of one embodiment of a system that can be used to practice aspects of the present invention.

FIG. 2A shows an exemplary diagram of one embodiment of the present invention.

FIG. 2B shows an exterior view of one embodiment of a control computing device and imaging devices according to one embodiment of the invention.

FIG. 2C shows a trigger monitoring computing device according to one embodiment of the invention.

FIG. 3 shows a schematic of a control computing device and imaging devices according to one embodiment of the invention.

FIGS. 4A and 4B show a schematic of a trigger monitoring computing device according to one embodiment of the invention.

FIG. 5 shows a control computing device, imaging devices, and a trigger monitoring computing device according to one embodiment of the invention.

FIG. 6 shows a schematic of a signal monitoring computing device according to one embodiment of the invention.

FIGS. 7-9 are flowcharts illustrating operations and processes that can be used in accordance with various embodiments of the present invention.

### DETAILED DESCRIPTION OF VARIOUS EMBODIMENTS OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Methods, Apparatus, Systems, and Computer Program Products

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, may be implemented in part by a processor in a computing system executing computer program instructions, e.g., as logical steps or operations. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### Brief Overview

In general, according to various embodiments of the present invention, methods, apparatus, systems, and computer program products are provided for surveillance, traffic monitoring, and red light enforcement. In various embodiments, the system includes a trigger monitoring computing device that determines when a vehicle enters and exits a particular zone of interest, such as a violation zone. In a particular embodiment, each time a vehicle enters or exits the violation zone, the trigger monitoring computing device transmits a time-stamped message to a control computing device. In this example, each time-stamped message indicates that an enter/exit has event occurred and the time it occurred.

In addition to the trigger monitoring computing device and the control computing device, the system may also include a signal monitoring computing device. In various embodiments, the signal monitoring computing device continuously monitors the state of one or more traffic signals to determine if the state of any of the signals has changed (e.g., from amber to red). In one embodiment, if the signal monitoring computing device determines that a signal has changed states, it sends a time-stamped message regarding the change to the control computing device.

The system may also include one or more imaging devices. For example, in one embodiment, the imaging devices continuously capture (and time stamp) images of surveillance zones. For example, in a particular embodiment, each lane of traffic at an intersection is monitored by an imaging device with a narrow angle lens, and the general area of the intersection is monitored by an imaging device with a wide angle lens. This allows for images to be captured at the intersection in general and for each lane of traffic.

In coordination with the other system components, the control computing device determines whether traffic violations occur, such as the running of red lights. Operatively, the control computing device continuously monitors the traffic signals of an intersection (e.g., by receiving status/state information from the signal monitoring computing device) and stores the status of their respective states. The control computing device also monitors the messages indicating vehicles traveling through the violation zone. Thus, for instance, when the control computing device determines that a traffic signal is red and that a vehicle has exited a violation zone while the light was red, the control computing device determines that a traffic violation has occurred. In this example, the control computing device can then request the images (that are taken continuously) from the imaging devices that start, for example, five seconds before the enter message and end five seconds after the exit message. The control computing device can then save the images and generate an evidence package for each traffic violation.

### Exemplary System Architecture

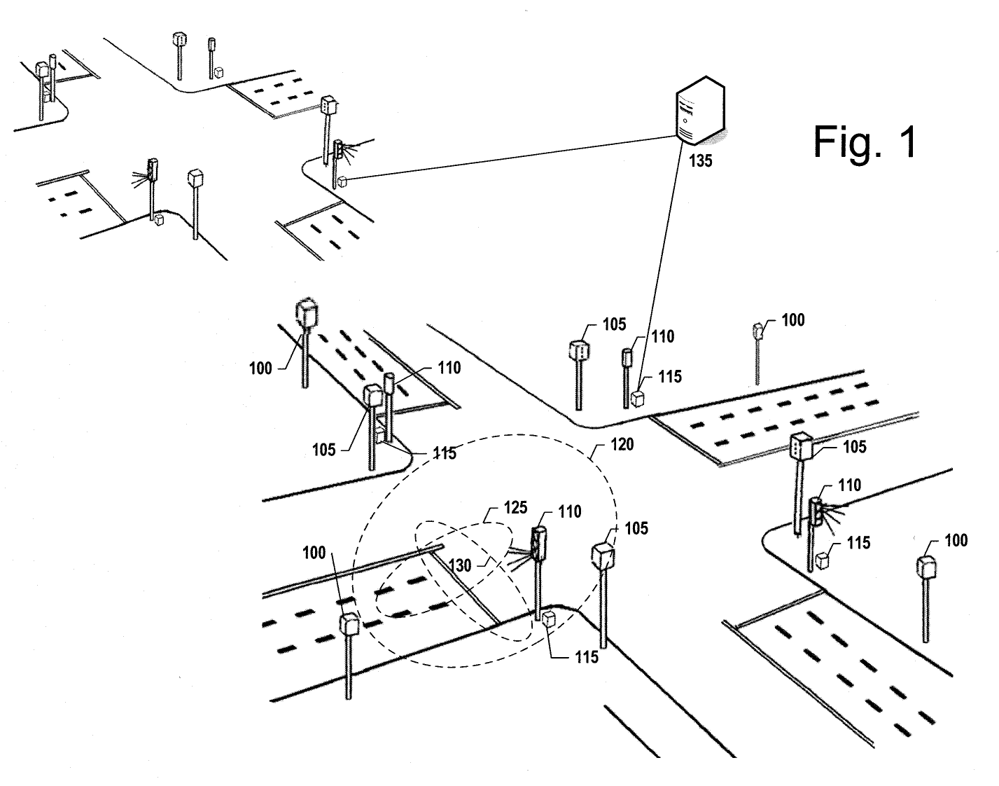

FIGS. 1, 2B, 2C, and 3 provide illustrations of one type of system that can be used in conjunction with various embodiments of the present invention. As shown in FIGS. 1, 2B, 2C, and 3, the system may include: a control computing device 300 (contained with the control housing 100); a trigger monitoring computing device 105; a traffic control system 110; a signal monitoring computing device 115; and one or more imaging devices 200, 205. In general, the term “computing device” is used generically to refer to any computer, desktop, notebook or laptop, terminal, distributed system, mainframe, server, gateway, switch, router, modem or other processing device configured to perform the functions described herein. The term “or” is used herein in both the alternative and conjunctive sense, unless otherwise indicated. Each of the components of the system may be in electronic communication with one another or other computing devices (or entities) over the same or different wireless or wired networks including, for example, a wired or wireless Personal Area Network (“PAN”), Local Area Network (“LAN”), Metropolitan Area Network (“MAN”), Wide Area Network (“WAN”), or the like. Additionally, while FIG. 1 illustrates the various system entities as separate, standalone entities, the various embodiments are not limited to this particular architecture. For example, the functionality of the control computing device 300, the trigger monitoring computing device 105, the traffic control system 110, and the signal monitoring computing device 115 may each occur on a single computing device, a server, a mainframe computer system, multiple distributed or centralized servers, or similar computer systems or network entities.

### Control Computing Device

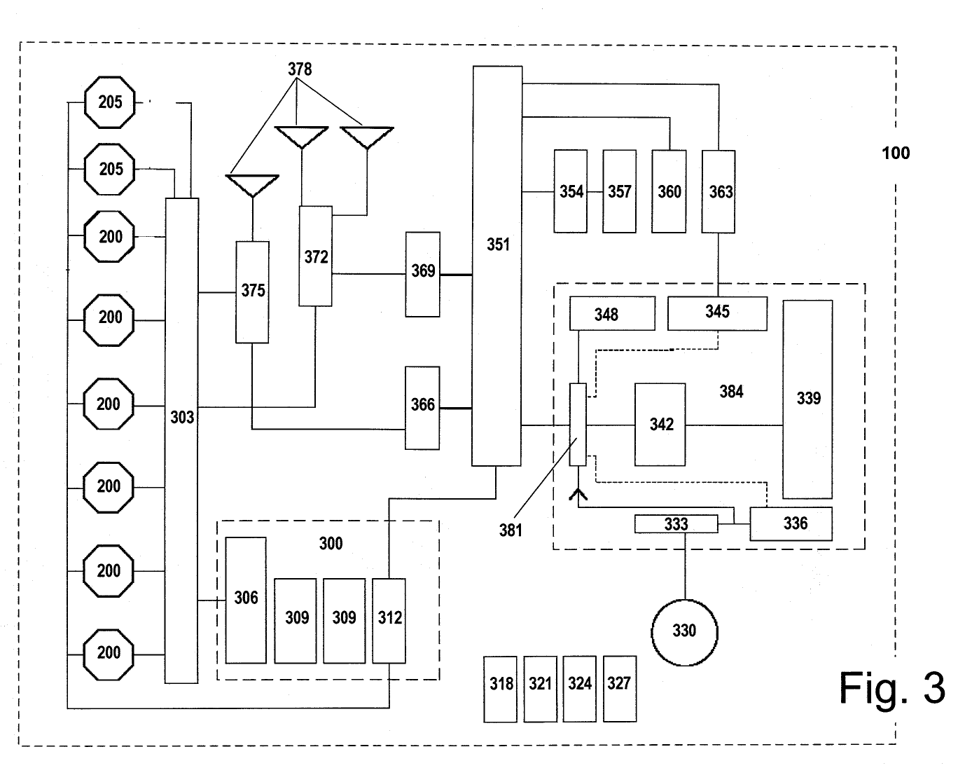

FIG. 3 provides a schematic of a control computing device 300 according to one embodiment of the present invention. In one embodiment, the control computing device 300 includes is a removable unit that comprises a processor 306 connected to memory 309 and a power supply 312. The processor 306 (may be attached to a motherboard, for example) communicates with other elements within the control computing device 300 via a system interface or bus. The processor 306 may be embodied in a number of different ways. For example, the processor 306 may be embodied as various processing means such as a processing element, a microprocessor, a coprocessor, a controller, a microcontroller or various other processing devices including integrated circuits such as, for example, an application specific integrated circuit (“ASIC”), a field programmable gate array (“FPGA”), a hardware accelerator, or the like. In an exemplary embodiment, the processor 306 may be configured to execute instructions stored in the device memory 306 or otherwise accessible to the processor 306. As such, whether configured by hardware or software methods, or by a combination thereof, the processor 306 may represent an entity capable of performing operations according to embodiments of the present invention while configured accordingly.

The memory 309 may comprise volatile memory and/or non-volatile memory. The volatile memory, for example, may comprise random access memory (“RAM”). The nonvolatile memory may comprise (a) read only memory (“ROM”) used to store a basic input/output system (“BIOS”) or (b) one or more storage devices, such as a hard disk drive, a CD drive, or an optical disk drive, for storing information on various computer-readable media. The computer-readable media may include any type of computer-readable media, such as embedded or removable multimedia memory cards (“MMCs”), secure digital (“SD”) memory cards, Memory Sticks, electrically erasable programmable read-only memory (“EEPROM”), flash memory, or the like. In one embodiment, the control computing device 300 includes two hard disk drives: (a) a first hard disk drive for storing the operating system, traffic violations, and video clips and (b) a second hard disk drive for storing video surveillance footage.

In one embodiment, the power supply 312 comprises a 12-volt direct current (“DC”), 15 amp power module (and an external power source).

Additionally, the control computing device 300 may be connected to (e.g., housed within the control housing 100) or include a network interface 375, such as a wireless Ethernet bridge (e.g., powered by a 6-volt, 5 amp DC power supply 366) or a wireless modem 372 with an Internet connection (e.g., powered by 6-volt, 1.25 amp power supply 369) for communicating with the other system components or other computing entities. This communication may be via the same or different wired or wireless networks (or a combination of wired and wireless networks). For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol. Similarly, the control computing device 300 may be configured to communicate via wireless external communication networks using any of a variety of protocols (e.g., by transmitting and receiving signals via the antennae 378), such as 802.11, general packet radio service (“GPRS”), wideband code division multiple access (“W-CDMA”), or any other wireless protocol. Via the network interface 375, the control computing device 300 can perform a variety of communications, including synchronize its time to a consistent network time (e.g., using network time protocol (“NTP”)). In a particular embodiment, the control computing device 300 synchronizes with an NTP server (e.g., any NTP server) via the Internet once each day, for example. The other computing devices (e.g., the trigger monitoring computing device 105, the signal monitoring computing device 115, and the one or more imaging devices 200, 205) synchronize with the control computing device 300 at periodic intervals via NTP, such as every 10-15 minutes. Clock synchronization, though, can also be implemented in a variety of different ways, e.g., a GPS or atomic clock.

Via the network interface 375, the control computing device 300 can also download changes, add-ons, and updates, for instance, to its firmware, software (e.g., modules), and operating system in memory 309. This also can be used to provide the user with information regarding the status and operation of the control computing device 300 and provide the user with the ability to resolve certain issues remotely.

In addition to housing the control computing device 300, the control housing 100 may include a removable power module 384 connected to 120 volt alternating current (“AC”) power source. The removable power module 384 may include a relay reset 381; a 12-volt power supply for the reset relay 336; a surge protector 348; a remote reset switch control 345; a circuit breaker 333; a 16 port switch 339; and a 5-volt, 8 amp power supply for the 16 port switch 342. The control housing 100 may also house (e.g., to maintain the environment within the control housing 100) a temperature sensor 318, a shock vibration sensor 321, a door open sensor 324, a light sensor 327, a thermostat 354, and a heat exchanger 357. Via at least some of these elements, the environment within the control housing can be maintained for optimal operating conditions (e.g., with the aid of a processor or actuator in communication with the sensors). The control housing 100 may also include an auxiliary lighting system 360, a 9-volt AC, 0.5 amp power supply 363 for the remote reset switch control 345. The remote reset switch control 345 controls the resetting of the power supply 363 when it receives a corresponding command.

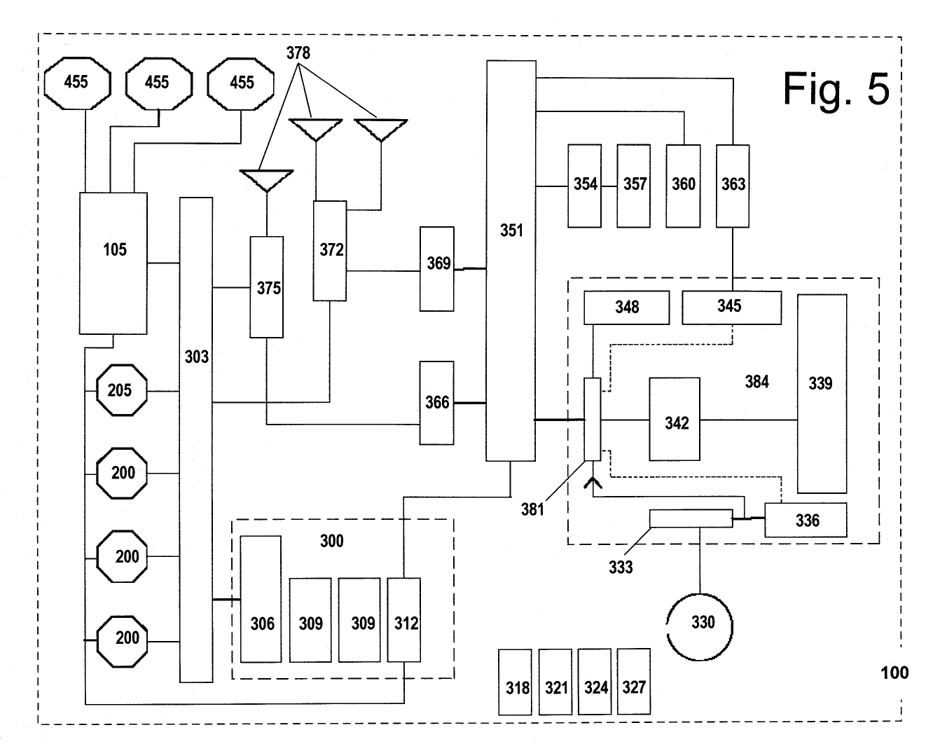

FIG. 5 provides a schematic of a control computing device 300 according to another embodiment of the present invention. In this embodiment, the control computing device 300 is housed with a traffic monitoring computing device 105 (described in greater detail below) within the control housing 100.

### Imaging Devices

In one embodiment, the control housing 100 also includes one or more imaging devices 200, 205 and a switch 303 for interfacing the imaging devices 200, 205 with the control computing device 300. Each imaging device 200, 205 may be any analog or digital camera, such as a Lumenera Le165c camera, (or video camera or combination thereof) for capturing images. For example, the imaging devices 200, 205 may be a camera with a wide angle lens (e.g., imaging device 205) or a camera with a narrow angle lens (e.g., imaging device 200). The imaging devices 200, 205 may also include a processor (not shown) and a temporary memory storage area (not shown), such as a circular buffer. Thus, the imaging devices 200, 205 can capture images and store them temporarily in the temporary memory storage area or permanently (in a separate memory storage area) within the imaging devices 200, 205 or transmit the images to the memory 309 of the control computing device 300. In one embodiment, the imaging devices 200, 205 are also connected to (or include) a network interface 375 (e.g., the wireless Ethernet bridge) for communicating with various computing entities. As indicated above, this communication may be via the same or different wired or wireless networks using a variety of wired or wireless transmission protocols. Via the network interface 375, the imaging devices 200, 205 may provide access for: (a) a user to remotely configure (e.g., control the exposure, gain, gamma, and white balance of the images) the imaging devices 200, 205; (b) remotely access the captured images; or (c) synchronize the time on the imaging devices 200, 205 to a consistent network time.

### Trigger Monitoring Computing Device

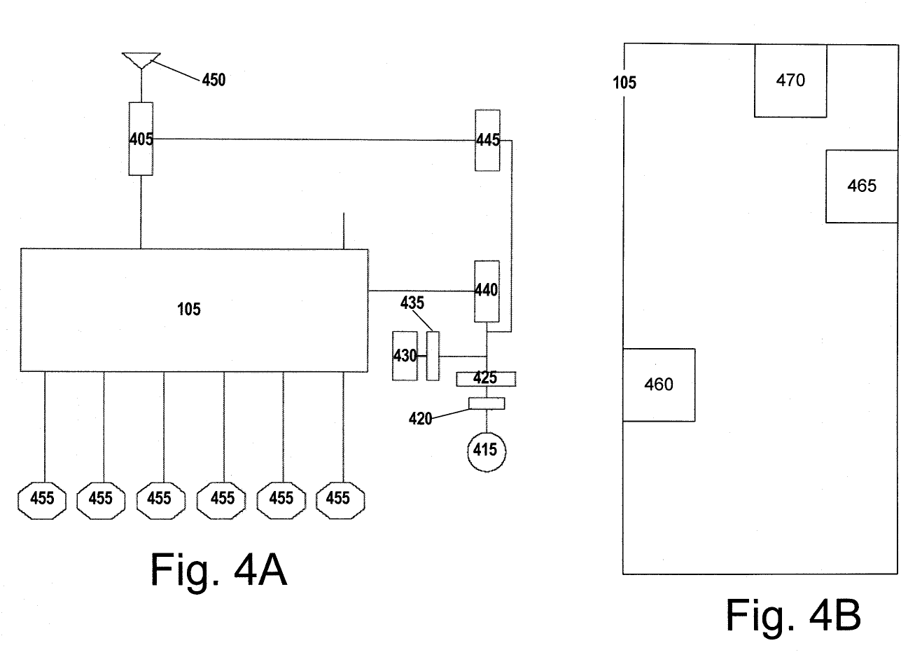

In one embodiment, the purpose of the trigger monitoring computing device 105 is to (a) monitor specific traffic-related events at various locations, such as traffic signals, stop signs, railroad crossings, and school zones; and (b) provide indications when the traffic-related events occur. FIGS. 4A, 4B, and 5 provide schematics of a trigger monitoring computing device 105 according to two embodiments of the present invention. In the embodiment shown in FIG. 4A, the trigger monitoring computing device 105 is housed separately from the control computing device 300. In the embodiment shown in FIG. 5, the trigger monitoring computing device 105 is housed with (and connected to) the control computing device 300 in the control housing 100. In both embodiments (shown in FIGS. 4A and 4B), the trigger monitoring computing device 105 may comprise a processor (not shown), a memory (not shown), trigger (e.g., LIDAR) connections 455, a network interface 460, a diagnostics interface 465, and a 12 volt DC power connecter 470. In the embodiment shown in FIG. 4A, the trigger monitoring computing device may also comprise or be connected to a network interface 405 (e.g., a wireless Ethernet bridge connected to an antenna 450) for communicating with other entities via one or more wired or wireless communications networks. Additionally, the trigger monitoring computing device 105 may also be connected to or housed with a 120 volt AC power source 415, a surge protector 420; a circuit breaker 425; a thermostat 435; a heat exchanger 430; 12-volt, 15 amp power supply 440 for the trigger monitoring computing device 105; and a 6-volt, 5 amp DC power supply 445 for the network interface 405. Via some of these elements, the environment within the control housing can be maintained for optimal operating conditions.

### Traffic Control Signal System

FIG. 1 shows a traffic control signal system 110 that can be used with embodiments of the present invention. The traffic control signal system 110 may control, for example, the green, amber, and red signals (e.g., traffic lights) of a traffic signal at an intersection. That is, the traffic control signal system 110 can coordinate and implement the changing of the traffic signals and crosswalks indicators.

### Signal Monitoring Computing Device

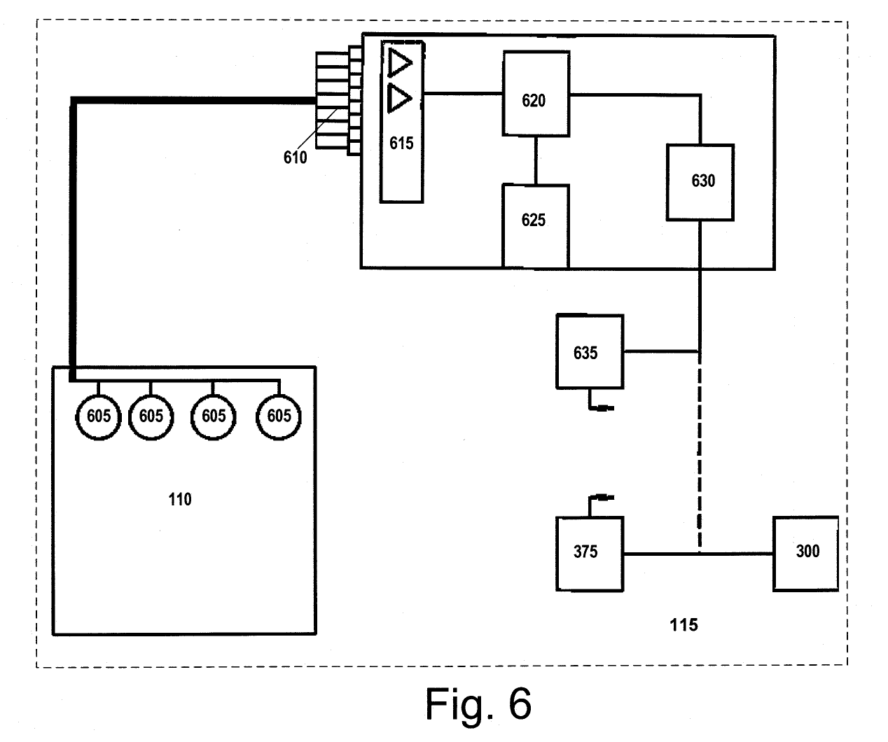

FIG. 6 provides a schematic of a signal monitoring computing device 115 according to one embodiment of the present invention. In one embodiment, the signal monitoring computing device 115 comprises a processor 620, networking hardware 630, a network interface 635, such as a wireless Ethernet bridge, a diagnostic port 625 (e.g., RS232), an amplifier section 615, and inductive pickup inputs 610. Via the network interface 635 (e.g., the wireless Ethernet bridge), the signal monitoring computing device 115 can communicate with the control computing device 300 via its network interface 375. As indicated above, this communication may be performed via a variety of wired or wireless connections and transmission protocols.

In one embodiment, to receive its inputs, the signal monitoring computing device 115 is connected to the traffic control signal system 110 via a wired connection. To monitor the signals of the traffic control signal system 110, there is an inductive pickup 605 for each traffic signal monitored. For example, the inductive pickup 605 can be configured as coil that encircles the wire providing power to illuminate the red or green light signal. In response to the traffic control signal system's 110 activation of the respective red or green light, the traffic control signal system 110 causes an electric current to flow in the wire to illuminate the red, amber, or green light. This action induces current in the inductive pick-up, generating a signal that can be detected by the inductive pickup 605.

### Exemplary System Operation

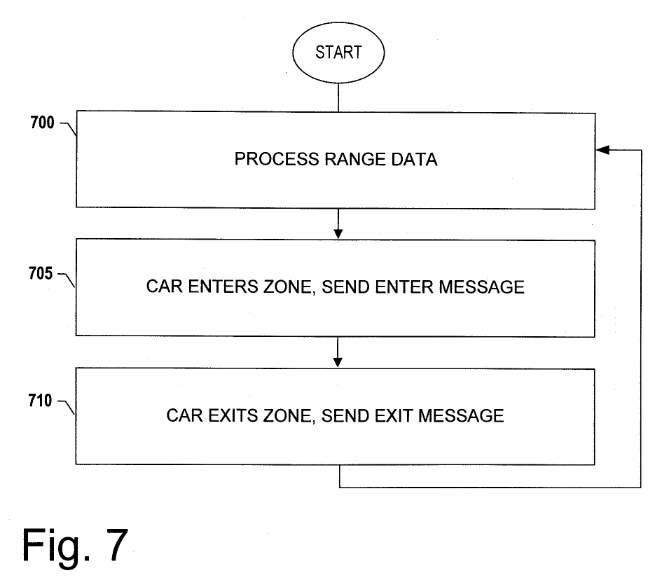

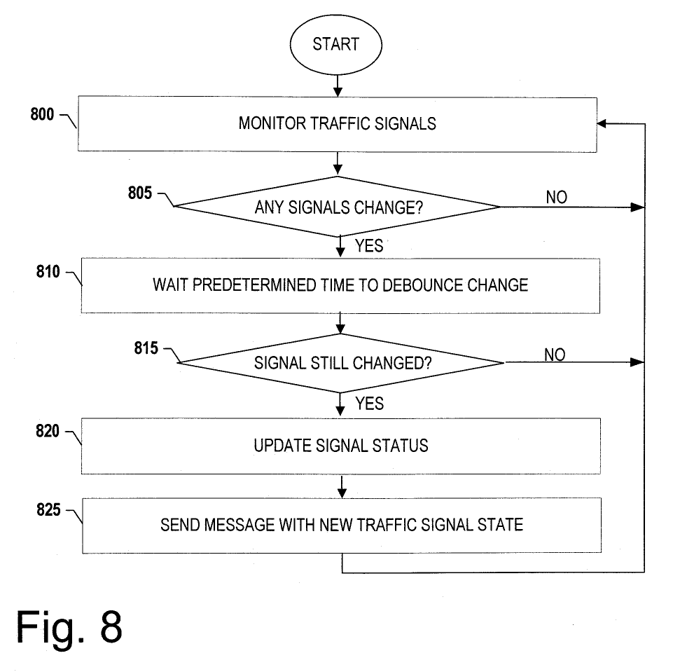

Reference will now be made to FIGS. 7-9, which provide examples of operations and input and output produced by various embodiments of the present invention. In particular, FIGS. 7-9 provide flowcharts illustrating operations that may be performed to monitor traffic. And although the following operations are described as being performed by particular computing entities for illustrative purposes, the operations may each occur on a single computing device, a server, a mainframe computer system, multiple distributed or centralized servers, or similar computer systems or network entities.

### Trigger Monitoring

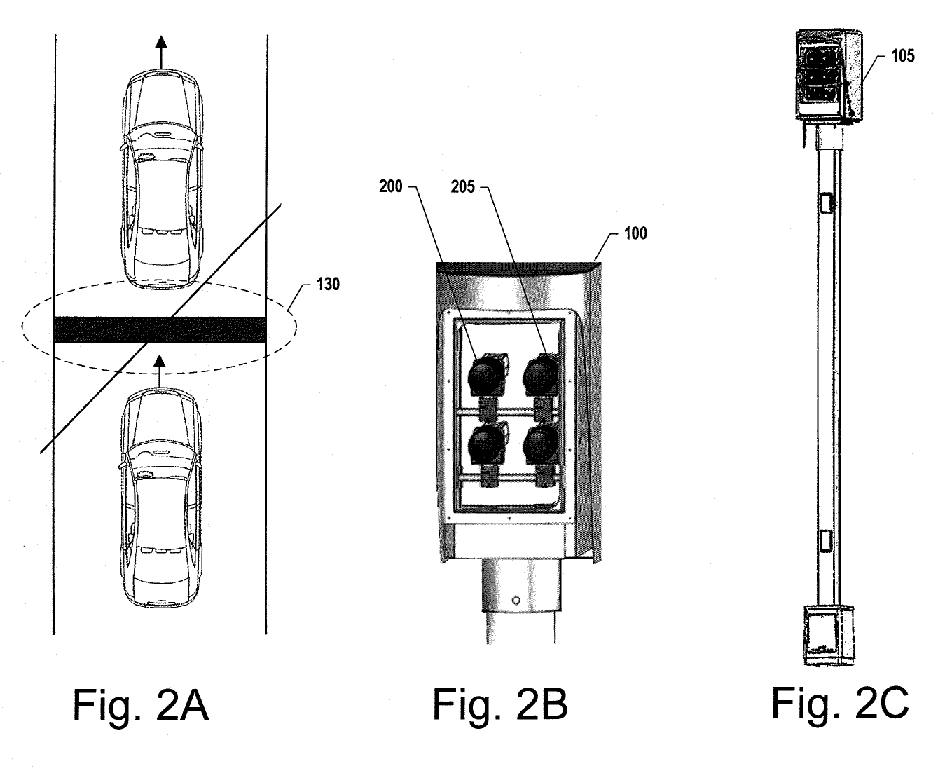

FIG. 7 provides operations performed, in one embodiment, by the trigger monitoring computing device 105. In particular, FIG. 7 shows operations that can be performed via the processor of the trigger monitoring computing device 105. For example, in one embodiment, the trigger monitoring computing device 105 identifies the occurrence of one or more events of interest. The events of interest may include a variety of traffic-related events, such as a vehicle entering and leaving a particular zone. For example, for a vehicle to “run a red light,” the vehicle will need to proceed past a particular area (e.g., zone) while a traffic signal associated with the area is red. Thus, in one embodiment, the trigger monitoring computing device 105 determines when a vehicle enters and exits a particular area, such as a “violation zone.” There may be multiple violation zones 130 for an intersection, such as a violation zone 130 for each lane of traffic. In one embodiment, the violation zone 130 is at (or includes) a point past the stop line for a traffic signal (an illustrative violation zone 130 is shown in FIGS. 1 and 2A). In one embodiment, each lane of traffic has its own violation zone 130. Determining when a car exits and enters the violation zone 130 can be performed using a variety of detection mechanisms, such as light detection and ranging (“LIDAR”), airborne laser swath mapping (“ALSM”), laser altimetry, laser detection and ranging (“LADAR”), and loop-sensor technologies (e.g., inductive loops).

In one embodiment, the trigger monitoring computing device 105 determines when a vehicle enters and exits the violation zone 130 using LIDAR (e.g., one LIDAR per lane of traffic). To do so, the LIDAR is pointed slightly beyond the far edge of the lane where the lane meets the violation zone. The LIDAR beam travels across the entire lane as low as possible without causing too much “shadowing” (shown in FIG. 2A). A minimum of two values are defined for each LIDAR: the minimum and the maximum range gates. The minimum range gate is the range at which the LIDAR's beam reaches the near edge of the lane being monitored. The maximum range gate is where the LIDAR's beam reaches the far edge of the lane being monitored. Because LIDAR is a sensing technology that measures properties of scattered light to find ranges or other information, it can therefore be used to determine the distance to an object or surface as indicated above. If the distance to the fixed point in the violation zone 130 is, for example, 200 feet, the LIDAR measurement will be less than 200 feet when a vehicle is in the path of the beam of the LIDAR (e.g., in the violation zone 130). Thus, by continuously measuring the distance to the fixed point in the violation zone 130, the trigger monitoring computing device 105 can determine when vehicles enter and exit the violation zone 130.

Operatively, the trigger monitoring computing device 105, via the LIDAR, continuously monitors the distance to a fixed point or area within the violation zone 130 (Block 700). When the LIDAR's beam is unobstructed, the LIDAR will provide a constant range, such as determining the distance to be 200 feet every five milliseconds. In contrast, when a car enters the beam of the LIDAR, the trigger monitoring computing device 105 will determine the distance to be a distance less than the constant range, e.g., 200 feet. If the range is determined to be less than 200 feet (accounting for a tolerance, if desired), the trigger monitoring computing device 105 generates and transmits (e.g., using the wireless Ethernet bridge) an “enter message” to the control computing device 300 (Block 705). The enter message provides an indication to the control computing device 300 that (a) a vehicle has entered the violation zone 130 and (b) the time the vehicle entered the violation zone 130. The time the vehicle enters (or exits) the violation zone 130 can be established by regularly synchronizing the various computing devices via NTP so that they all have the same corresponding network time. Additionally, as indicated above, the trigger monitoring computing device 105 can allow for minor discrepancies (tolerances) with respect to the distance. For example, if the distance is determined to be 198 feet, the trigger monitoring computing device 105 can be configured to not generate an enter message—allowing for minor error tolerances in the distance. Once the car exits the violation zone 130 (e.g., the trigger monitoring computing device 105 determines the distance to the point in the violation zone 130 to be 200 feet), the trigger monitoring computing device 105 generates and transmits an “exit message” to the control computing device 300. The “exit message” provides an indication to the control computing device 300 that (a) the vehicle has exited the violation zone 130 and (b) the time the vehicle exited the violation zone 130. Thus, the trigger monitoring computing device 105 generates and transmits two packets of information to the control computing device 300 for each vehicle that passes through the violation zone 130: an enter message and an exit message (providing the time that each event occurred). That is, the operations shown in FIG. 7 (Blocks 700, 705, 710) can be repeated continuously to monitor vehicles entering and exiting the violation zone 130. Also, it should be noted that in one embodiment, by using LIDAR and wirelessly transmitting the enter and exit messages, no roadwork is necessary to install or operate the trigger monitoring computing device 105. In other embodiments, a variety of other detection mechanisms can be used to determine when cars pass a particular area, including inductive loops installed in the roadway.

In addition to providing enter and exit messages, the trigger monitoring computing device 105 can perform a variety of other functions. For example, in a particular embodiment, traffic statistics can be provided, such as car counts by lane and time of day and vehicle classification counts (large truck vs. standard vehicle). The trigger monitoring computing device 105 can generate car counts representing the number of cars that pass through the violation zone 130 during a given time period (e.g., by determining the total enter and exit messages sent to the control computing device 300). The trigger monitoring computing device 105 can also determine the speed of vehicles passing through the violation zone 130 (e.g., for issuing speed violation citations). For example, to make speed determinations, the LIDAR calculates the range of the vehicle and the change in that range is used to calculate the speed of the vehicle. In the case of an approaching vehicle, the speed is calculated when the vehicle first enters the zone of interest. In the case of a receding vehicle, the speed is calculated as the vehicle is leaving the zone of interest. This information (which may also include statistics regarding red light violations) may be useful for assessments used in urban or residential planning and development, which frequently require traffic flow studies to be undertaken by developers in order to obtain approval of new developments.

### Signal Monitoring

FIG. 8 provides operations performed, in one embodiment, by the signal monitoring computing device 115. In particular, FIG. 8 shows operations that can be performed by the processor 620 of the signal monitoring computing device 115. For example, in one embodiment, the signal monitoring computing device 115 monitors the various states of one or more traffic signals controlled by a traffic control system 110 (Block 800). The “states” of a traffic signal generally refer to a traffic signal's green, amber, and red light signals. As indicated above, the signal monitoring computing device 115 can monitor one or more traffic signals by being connected to a traffic control system 110, e.g., by clamping onto the wires of the traffic control system 110 for noninvasive monitoring.

In operation (Block 805), the signal monitoring computing device 115 continuously monitors (e.g., every 10 ms) the state of one or more traffic signals to determine if the state of any of the signals has changed (e.g., from amber to red). If the signal monitoring computing device 115 determines that a signal has changed states, it waits a predetermined period of time (e.g., 55 milliseconds) to debounce the change (Block 810). The debounce period is used to filter noise (e.g., noise generated from inductive loops and amplification components) from an actual traffic signal change. After waiting the predetermined time, the signal monitoring computing device 115 determines if the traffic signal is still changed (Block 815). If the traffic signal is still changed, the signal monitoring computing device 115 updates the signal status variables (Block 820) and sends a message (Block 825) regarding the change to the control computing device 300 (e.g., a green signal message, an amber signal message, or a red signal message). For example, in one embodiment, a time stamp of when the change was first detected (before the debounce time passed) and an eight-bit status indicate which of eight lights being monitored is illuminated.

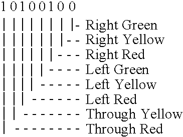

In the above example, the through green light signal is not monitored because there is always a through green light signal at every intersection. The lack of through red light signals and through yellow light signals indicates that the through green light signal is illuminated. With the turn arrows, however, certain turn arrows may not be present, forcing the turn lanes to default to the through lanes' state. In this embodiment, all six types of arrows that could exist are monitored.

In one embodiment, by transmitting the messages wirelessly (e.g., via a wireless Ethernet bridge), no roadwork is necessary to install or operate the signal monitoring computing device 115. In other embodiments, however, the signal monitoring computing device 115 can communicate with the control computing device 300 (and other computing entities) via a wired communications medium. The messages may indicate (a) that a particular traffic signal has changed states, (b) the current state of the traffic signal, and (c) the time the traffic signal changed states (e.g., using an NTP time stamp). Similar to the trigger monitoring computing device 105, the time for the signal monitoring computing device 115 can also be established by regularly synchronizing the various computing devices via NTP so that they all have the same corresponding network time.

In an alternative embodiment, only the red light signal wire is monitored by attachment of an inductive pickup 605. For example, in this embodiment, in response to the traffic signal turning red, as current flows in the red light signal wire, the inductive pickup 605 detects the current and generates a signal to the processor 620 of the signal monitoring computing device 115. The processor 620 can then wait a predetermined period of time (e.g., 55 milliseconds) and check the signal from the inductive pickup 605 again to ensure that the state of the red light signal has indeed changed, and was not merely noise. If the rechecking indicates that the signal was noise, the processor 620 disregards the initial signal. In contrast, if the processor 620 determines that the signal from the inductive pickup 605 indicates that the red light signal has been illuminated, the processor 620 obtains the time stamp for the initial signal change from an internal (or external) source within the signal monitoring computing device 115 and generates a time-stamped red signal message. In the message, the processor 620 can include a header identifying itself as the unit reporting the red signal message and add appropriate protocol, routing, and parity or error check bits to ready the red signal message for transmission. At this point, the processor 620 transmits this red light message to the control computing device 300 via the network interface 375.

When the traffic signal changes to a green signal, the traffic control system 110 stops or significantly reduces the current on the red light signal wire to extinguish the red light. This change from high to low current is sensed by the inductive pickup 605, which generates a corresponding signal to the processor 620. The processor 620 waits a predetermined period of time (e.g., 55 milliseconds) and checks the signal from pickup device 605 again to ensure that the state of the red light signal has indeed changed, and was not merely noise. If the rechecking indicates that the signal was noise, the processor 620 disregards the initial signal. However, if the processor 620 determines that the signal from the inductive pickup 605 indicates that the red light signal is no longer illuminated, the processor 620 obtains the time stamp for the initial signal change from an internal (or external) source within the signal monitoring computing device 115 and generates a time-stamped green signal message. In the message, the processor 620 can include a header identifying itself as the unit reporting the green signal message and add appropriate protocol, routing, and parity or error check bits to ready the green signal message for transmission. The processor 620 then communicates the green light message to the central computing device 300 via the network interface 375.

Alternatively, in lieu of using the inductive pickup 605 on the red light signal wire to monitor state changes, an inductive pickup 605 can be connected to the green light signal wire and connected to the processor 620 via the inductive pickup inputs 610 and amplifier section 615. For example, the processor 620 can be programmed to generate a green light message in response to significant current flowing in the green light signal wire. In this example, the processor 620 may also be configured to recheck the signal after a predetermined time delay to confirm that the current is flowing in the wire to illuminate the green light signal. If the rechecking indicates that the signal was noise, the processor 620 disregards the initial signal. If the processor 620 determines that the signal from the inductive pickup 605 indicates that the green light signal has been illuminated, the processor 620 obtains the time stamp for the initial signal change from an internal (or external) source within the signal monitoring computing device 115 and generates a time-stamped green light message. The processor 620 transmits this green light message to the central computing device 300 via the network interface 375.

It is possible in an alternative embodiment that the need to recheck the state of the red and green light signals can be omitted by programming the processor 620 to generate the red light message only if the red light inductive pickup 605 indicates that the red light signal is illuminated and the green light inductive pickup 605 indicates that the green light signal is not illuminated. Similarly, the processor 620 can be programmed to generate the green light message when the green light inductive pickup 605 indicates the green light signal is illuminated and the red light inductive pickup 605 indicates the red light signal is not illuminated. However, in some environments, noise may impact both the red and green light signal wires simultaneously. In such environments, configuring the processor 620 to recheck the green and red light signal states after a predetermined delay may be desirable.

Further noise immunity can be added to the signal monitoring computing device 115 by monitoring the state of the amber light signal. In this embodiment, another inductive pickup 605 can be attached to the amber light signal wire to monitor the amber light signal's state. In this example, the processor 620 is configured to generate the red light message in response to the red light signal activating and the amber light signal deactivating, and not otherwise. This provides some immunity to noise because the current flows in the red and amber signal wires are in opposite states at the time of switching the red and amber light signals. The same is true of the red and green lights, and the processor 620 can be configured to generate the green light signal only in response to the red light signal being in a deactivated state and the green light signal being in an active state, as sensed by the inductive pickup 605.

### Imaging

As indicated above, in one embodiment, the control housing 100 includes one or more imaging devices 200, 205 that interface with the control computing device 300. Each of the imaging devices 200, 205 can be synchronized with the control computing device 300; the trigger monitoring computing device 105; and the signal monitoring computing device 115 using NTP. The number of imaging devices 200, 205 at an intersection may vary based on the desired configuration. For example, in one embodiment, each lane of traffic at an intersection is monitored by an imaging device 200 with a narrow angle lens (e.g., one imaging device 200 per lane of traffic). By capturing narrow angle (or more-focused) images for each lane of traffic (e.g., a “first surveillance zone” 125), the imaging devices 200 can be configured to capture images of the licenses plates of the vehicles traveling in the respective lanes of traffic. In addition to the imaging device 200 with a narrow angle lens, an imaging device 205 with a wide angle lens can be used to monitor, for example, three to six lanes of traffic at the intersection (e.g., a “second surveillance zone” 120). By capturing wide angle images, the imaging device 205 device can provide surveillance of the occurrences at the intersection throughout the day. Thus, in one embodiment, each lane is monitored by two imaging devices 200, 205: an imaging device 200 with a narrow angle lens and an imaging device 205 with a wide angle lens. This allows for the images to be captured at the intersection in general (e.g., the imaging device 205 with a wide angle lens capturing images of the second surveillance zone 120) and for each lane of traffic (e.g., the imaging device 200 with a narrow angle lens capturing images of the violation zone 130 within the first surveillance zone 125).

In one embodiment, the imaging devices 200, 205 (a) continuously capture images, (b) time stamp the captured images, and (c) temporarily store them in a temporary memory storage area, such as a circular buffer. This allows the images to be retrieved by time-stamp (and contiguous images can be retrieved given a starting time-stamp). For example, in one embodiment, the circular buffer of each imaging device 200, 205 may have capacity to store 30-40 seconds of images. Thus, every 30-40 seconds, the memory locations storing the “old” images can be overwritten to store the “new” images. The time-stamped images are stored, for example, with the sequence number and the picture number together in a suitable format. In one embodiment, the time-stamp for each image includes the time, date, and location. This image capturing can be repeated throughout the day. The images can also be sent from the imaging devices 200, 205 to the memory 309 of the control computing device 300 for permanent storage. In a particular embodiment, the memory 309 is a hard drive designed for use in a digital video recorder (“DVR”) (e.g., made for greater than 50% continual usage). To store the images, the control computing device 300 requests the video stream from the imaging device 205 across the network and saves it in memory 309 by time stamp. As the memory 309 nears capacity (or a determined threshold), the control computing device 300 deletes the “oldest” images and replaces them with the “newest” images, operating in a manner similar to a circular buffer. The images can then be encrypted and watermarked or digitally signed to protect against tampering. For example, the imaging devices 200, 205 invisibly time stamp the images and the control computing device 300 adds a databar to the images used in an evidence package and encrypts and saves them to memory 309 as part of an evidence package. Thus, all intersection activity can be stored for days, weeks, or months and be available as a special search function to provide video evidence of any events within the field of view (e.g., within the second surveillance zone) of the intersection imaging devices 200, 205, e.g., accidents or altercations.

In another embodiment, the imaging device 205 with the wide angle lens captures images continuously, while the imaging device 200 with the narrow angle lens captures images after the traffic signal turns red. In this embodiment, the imaging device 200 receives a capture command from the control computing device 300, indicating that the traffic signal associated with the imaging device 200 has turned red. After receiving the capture command, the imaging device 200 begins capturing images within, for example, 66 milliseconds from the command and continues capturing images at 15 frames per second. In a particular embodiment, the imaging device 205 transmits the time-stamped images to the control computing device 300 for archival storage.

In yet another embodiment, the imaging devices 200, 205 can be configured to capture images using a noise detection mechanism. For example, in response to a noise over a certain decibel (e.g., a car accident), using a noise detection mechanism, the imaging devices 200, 205 can be configured to capture images of the first and second surveillance zones. These images can be later requested and retrieved for viewing if stored to a form of permanent memory internal to the imaging device 200, 205, or alternatively or in addition, such time-stamped images can be transmitted automatically to the control computing device 300 or other remote computing device for permanent or archival storage. Alternatively, the noise detection mechanism can generate and transmit a signal indicating noise detection to the control computing device 300, responsive to which the control computing device 300 can request the imaging devices 200, 205 to transmit images time-stamped at or near the time indicated by the noise detection mechanism's message to the control computing device 300. Such images may be used for compiling evidence reports or packages surrounding an incident captured by the imaging devices 200, 205 for proving a traffic violation in court or administrative proceedings. The images may also be useful for determination of fault, evidence of vehicle or property damage, or personal injury for insurance purposes, for example. The control computing device 300 can be configured to generate the evidence packages itself, or may transmit the images to a remote computing device operated by personnel responsible for compiling evidence packages for police departments or insurance companies.

Similarly, the imaging devices 200, 205 can be accessed via the network by the control computing device 300 or another computing device, for example, to obtain live surveillance of the various zones. In a particular embodiment, this feature may be used to monitor or analyze the flow of traffic for traffic control or police purposes, such as observing driving patterns, monitoring the safety of the various zones, or looking for suspect vehicles.

As indicated, in one embodiment, the imaging devices 200, 205 are configured to capture at least 15 images per second (e.g., operating at 15 frames per second) of their respective surveillance zones. By capturing images at this rate, the images can be combined, if desired, to create a video clip from a specific time period. The resolution of the images captured by the imaging device 200, 205 may be, for instance, 640 pixels by 480 pixels or higher. In one embodiment, for night operation, the imaging devices 200, 205 may have a sensitivity of 0.5 lux or better at an optical stop equivalent of F1. The images can also be in a variety of formats, such as JPEG, MJPEG, MPEG GIF, PNG, TIFF, and BMP.

The imaging devices 200, 205 may also be connected to (or include) a network interface 375 (e.g., the wireless Ethernet bridge) for communicating with various computing entities. In one embodiment, the imaging devices 200, 205 can communicate with the control computing device 300 using protocols and stacks, such as sockets. The network interface provides the ability for each imaging device 200, 205 to serve as a web host with, for example, web pages that can be used to setup and configure the imaging devices 200, 205. Moreover, via the web pages (or via the control computing device 300), the imaging devices 200, 205 can provide a live view of the first and second surveillance zones, which can be used to aim and focus the imaging devices 200, 205. This also provides the functionality of controlling the exposure, gain, gamma, white balance, JPEG compression, and numerous other attributes of the imaging devices 200, 205. Thus, via the network interface 375, the imaging devices 200, 205 may provide access for: (a) a user to remotely configure (e.g., control the exposure, gain, gamma, and white balance of the images) the imaging devices 200, 205; (b) remotely access the captured images; or (c) synchronize the time on the imaging devices 200, 205 to a consistent network time.

### Surveillance and Violation Monitoring

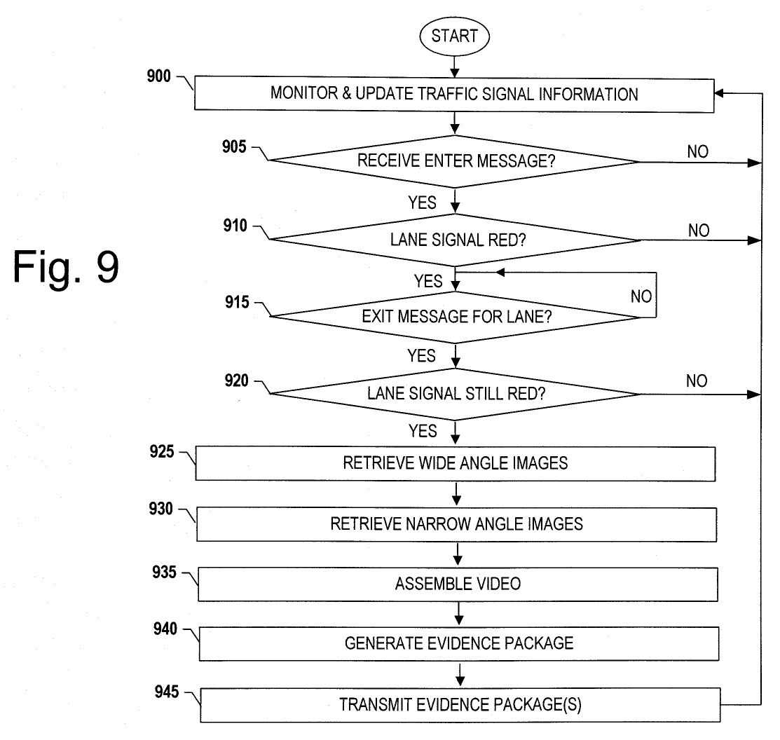

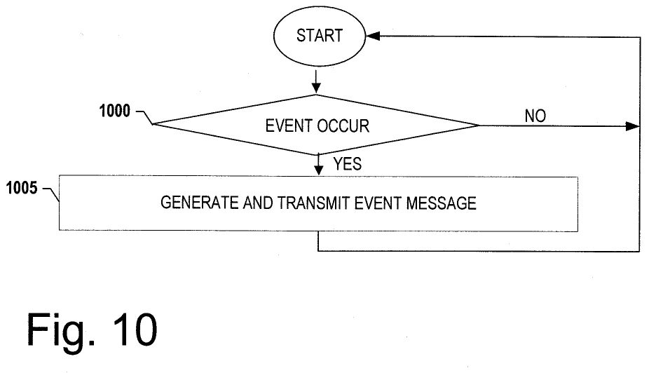

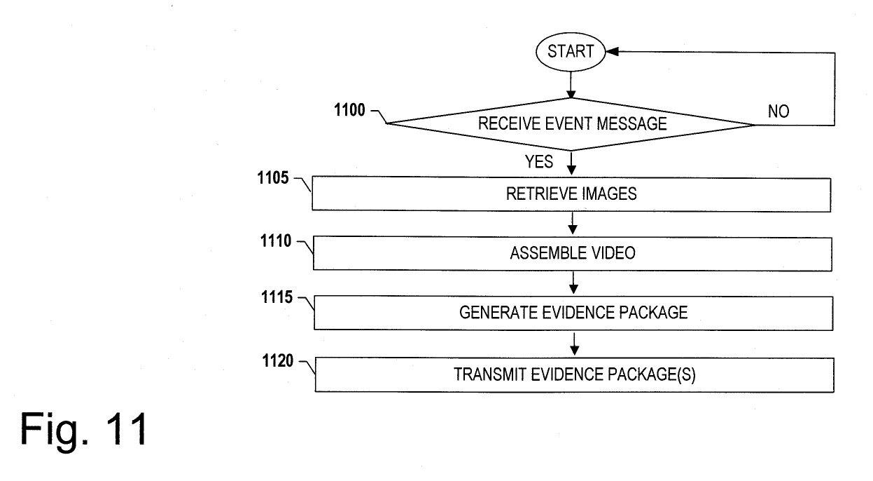

FIG. 9 provides operations performed, in one embodiment, by the control computing device 300 (or a single remote computing device 135 configured to provide surveillance and violation monitoring for multiple intersections (shown in FIG. 1)). In particular, FIG. 9 shows operations that can be performed by the processor 306 of the control computing device 300. For example, the control computing device 300 determines whether traffic violations occur, such as the running of red lights. To do so, in one embodiment, the control computing device 300 is configured to operate in a multi-threaded nature to allow for the monitoring and capturing of images of each lane of traffic using various threads. For example, the control computing device 300 creates threads to handle concurrent tasks that need to be performed by the control computing device 300. The concurrent tasks may include collecting evidence for multiple violators simultaneously, storing video streams from each wide-angle imaging device 205, receiving messages from the trigger monitoring computing device 105 and the signal monitoring computing device 115, transferring files via FTP for further processing, cleaning disk storage areas, updating the live video feeds, and creating custom video clips. Also, the control computing device 300 can be synchronized with the trigger monitoring computing device 105; the signal monitoring computing device 115; the imaging devices 200, 205 using NTP. Thus, in response to an event occurring or a message being generated, each of the system components or devices can determine the actual time the event occurred or message was generated (e.g., via a time stamp). An exemplary process of determining a red light violation is provided below.

Operatively, the control computing device 300 continuously monitors the traffic signals of an intersection (e.g., by receiving status/state information from the signal monitoring computing device 115) and stores the status of their respective states (Block 900). For example, the traffic signal state is saved for the left, through, and right lights. The state includes the color of the light (red, amber, or green), the time the red light signal was illuminated (if the red light signal is illuminated), and the duration of the yellow-light cycle that occurred immediately before the red-light cycle (if the red light signal is illuminated). The through state is determined based on the messages received from the signal monitoring computing device 115. The left and right turn states are initially defaulted to the through signal's state. If a turn arrow is illuminated for a given direction, that turn arrow will be given priority for that turn direction over the through signal's state. If a turn arrow is not illuminated or does not exist in a given traffic-signal configuration, that turn direction's state will remain defaulted to the through signal's state. This accounts for traffic-signal configurations that may or may not include any number of types of turn arrows (left red, amber, and green and right red, amber, and green).

The control computing device 300 also monitors the messages indicating vehicles traveling through the various violation zones 130 corresponding to the respective traffic signals. For example, in response to a vehicle entering a violation zone 130, the trigger monitoring computing device 105 monitoring the particular violation zone 130 sends an enter message to the control computing device 300. The enter message provides notification to the control computing device 300 that (a) a vehicle has entered the violation zone 130 (identifying the particular violation zone 130) and (b) the time the vehicle entered the violation zone 130. Thus, after receiving the enter message (Block 905), the control computing device 300 determines if the traffic signal corresponding to the violation zone 130 is red (Block 910). If the traffic signal is not red, the control computing device 300 continues to monitor the traffic signal states and the enter and exit messages. If the corresponding traffic signal is red, the control computing device 300 determines if an exit message associated with the violation zone 130 has been received from the trigger monitoring computing device 105 (Block 915). As previously indicated, exit messages provide notification to the control computing device 300 that (a) the vehicle has exited the violation zone 130 (identifying the particular violation zone 130) and (b) the time the vehicle exited the violation zone 130. If an exit message has not been received, the control computing device 300 continues to monitor for an exit message corresponding to the violation zone 130. Once an exit message is received, the control computing device 300 determines if the traffic signal corresponding to the violation zone 130 is still red (Block 920), e.g., using the time stamps of the enter and exit messages. If the traffic signal is still red, a violation is determined to have occurred. If the traffic signal is no longer red, a violation is determined to not have occurred.

In the event of a violation, the control computing device 300 requests images of the violation from the imaging devices 200, 205 (Blocks 925, 930). For example, using the time stamp of the exit message, the control computing device 300 can request the images from the imaging devices 200, 205 that start, for example, five seconds before the enter message and end five seconds after the exit message (the length of times may vary). In one embodiment, the various images include an image of the vehicle before reaching the violation zone 130 and an image of the vehicle past the violation zone 130. In this example, the images from the imaging device 200 with the narrow angle lens provide images of the vehicle's license plate (e.g., a first subset of images of the first surveillance zone), which may be retrieved from the imaging device 205 or the memory 309 of the control computing device 300. The images from the imaging device 205 with the wide angle lens provide images of the intersection in general (e.g., a second subset of images of the second surveillance zone). In these embodiments (Block 935), the images can be used to assemble a video of the violation, e.g., a video clip. The images and video can be saved in the memory 309 if the control computing device 300 as an evidence package (Block 940). In one embodiment, by requesting the images after the violation has occurred, the control computing device 300 reduces processing requirements on the processor 306.

In one embodiment, the control computing device 300 can generate, store, and transmit evidence packages for a variety of traffic violations. For example, an evidence package for a red light violation may include: (1) a color image of the first violation zone showing the vehicle's license plate with sufficient resolution across the characters for easy screen viewing; (2) a color image of the second surveillance zone showing the general conditions at the intersection including (a) the traffic signal, (b) the vehicle, and (c) the vehicle before arriving at the violation zone 130; (3) a color image of the second surveillance zone showing the general conditions at the intersection including (a) the traffic signal, (b) the vehicle, and (c) the vehicle over the violation zone 130; and (4) a video sequence (e.g., an assembly of images from the second surveillance zone) that captures the general conditions at the intersection, for example, three seconds before the violation and three seconds after the violation. With this information, a citation can be issued. In one embodiment, an evidence package is included with the citation indicating: (a) the vehicle owner's name and address; (b) an image of the license plate of vehicle; (c) one or more images of the violation; (d) the date, time, and location of the violation; and (e) the statute citing the law.

The evidence packages can vary depending on the nature of the violations and the customizations of the user. For example, the various computing devices can be used for speed enforcement, stop sign enforcement, and railroad crossing enforcement. Thus, depending on the violation, the exemplary embodiments can be modified to accommodate the changes. The evidence packages can be uploaded from the control computing device 300 in a variety of intervals, such as in real-time, once a day, multiple times a day, once a week, or once a month (Block 945). The operations can be performed continuously to provide automated monitoring and red light enforcement.

### Alternative Embodiments

Embodiments of the present invention can also be used in contexts other than traffic enforcement, such as in the surveillance of buildings, parking garages, cross-walks, and various other “zones of interest.” For example, FIGS. 10 and 11 provide steps that can be performed by an event monitoring computing device and a control computing device 300 respectively to monitor one or more surveillance zones. In one embodiment, the event monitoring computing device and one or more imaging devices 200, 205 are synchronized to (and interface with) the control computing device 300. As indicated above, the imaging devices 200, 205 (a) continuously capture images, (b) time stamp the captured images, and (c) temporarily store them in a temporary memory storage area, such as a circular buffer (which allows the images to be retrieved by time-stamp).

Although a schematic of an illustrative event monitoring computing device is not shown, the event monitoring computing device may include components similar to those of the signal monitoring computing device 115 and/or the trigger monitoring computing device 105, such as a processor, one or more memory storage areas, networking hardware, and a network interface. As shown in FIG. 10, in one embodiment, the event monitoring computing device (a) determines when particular events occur, (b) and generates and transmits “event messages” to the control computing device 300 (Blocks 1000 and 1005). The event messages indicate (a) that an event has occurred (and, in some embodiments, the type of event) and (b) the time the event occurred in accordance with the corresponding network time. Depending on the scope of the surveillance, the events may indicate a variety of occurrences, such as a car entering a parking garage (e.g., driving over a sensor), a person entering or exiting a building (e.g., a sensor indicating that a door was opened), or a person pressing a cross-walk button. Thus, the purpose of the event monitoring computing device is to provide information to the control computing device 300 about when particular events occur. In one embodiment, the event monitoring computing device can be housed with the control computing device 300. In yet another embodiment, the functionality of the event monitoring computing device can be performed by the control computing device 300, e.g., the event monitoring computing device can be replaced by the control computing device 300.

The control computing device 300 receives event messages indicating (a) that an event has occurred and (b) the time the event occurred in accordance with the corresponding network time (Block 1100). In response to receiving an event message(s), the control computing device 300 requests images of the surveillance zone from the imaging devices 200, 205 (Block 1105). For example, using the time stamp of the event message, the control computing device 300 can request the images from the imaging devices 200, 205 that start, for example, five seconds before the event message and end five seconds after the event message (the length of times may vary). The images can be used to assemble a video of the event, e.g., a video clip (Block 1110). The images can also be sent from the imaging devices 200, 205 to the memory 309 of the control computing device 300 for permanent storage. With the images or video, the control computing device 300 can generate and store evidence packages of the surveillance zone associated with the various events (Block 1115). The control computing device 300 may also be configured to transmit the evidence packages to a computing device, such as a remote computing device operated by personnel responsible for compiling evidence packages for police departments or monitoring agencies.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An event monitoring system comprising:
a first imaging device configured to
capture a first set of images of a first surveillance zone;
time stamp the first set of captured images respectively in accordance with a corresponding network time; and
store the first set of captured images in a temporary memory storage area of the first imaging device;
an event monitoring computing device comprising one or more processors configured to
determine when an event occurs proximate the first surveillance zone;
generate and transmit an event message indicating (a) that an event has occurred proximate the first surveillance zone and (b) the time the event occurred in accordance with the corresponding network time;
a control computing device comprising one or more memory storage areas and one or more processors, the one or more processors configured to
request a subset of the first set of images of the first surveillance zone from the temporary memory storage area of the first imaging device and store the first set of images in the one or more memory storage areas of the control computing device.

2. The system of claim 1, wherein the one or more processors of the event monitoring computing device are further configured to wirelessly transmit the event messages to the control computing device.

3. The system of claim 1 further comprising a second imaging device configured to
capture a second set of images of a second surveillance zone, wherein the first surveillance zone is within the second surveillance zone;
time stamp the second set of captured images respectively in accordance with corresponding the network time; and
store the second set of captured images in a temporary memory storage area of the second imaging device.

4. The system of claim 3, wherein the one or more processors of the control computing device are further configured to request a subset of the second set of images of the second surveillance zone from the temporary memory storage area of the second imaging device.

5. The system of claim 4, wherein the one or more processors of the control computing device are further configured to store the subset of the first set of images of the first surveillance zone and the subset of the second set of images of the second surveillance zone.

6. The system of claim 4, wherein the first and second imaging devices are further configured to allow remote access via a network.

7. The system of claim 4, wherein the temporary memory storage areas of the first and second imaging devices comprise circular buffers.

8. The system of claim 4, wherein the first set of images of the first surveillance zone comprise narrow angle images.

9. The system of claim 4, wherein the first set of images of the first surveillance zone comprise wide angle images.

10. The system of claim 1, wherein the network time is established by synchronizing the first imaging device, the second imaging device, the event monitoring computing device, and the control computing device via a network time protocol (NTP).

11. The system of claim 1, wherein the one or more processors of the control computing device are further configured to generate an evidence package comprising at least a portion of the first and second sets of images.

12. An event monitoring system comprising:
a first imaging device configured to
capture a first set of images of a first surveillance zone;
time stamp the first set of captured images respectively in accordance with a corresponding network time; and
store the first set of captured images in a temporary memory storage area of the first imaging device;
a control computing device comprising one or more memory storage areas and one or more processors, the one or more processors configured to
determine when an event occurs proximate the first surveillance zone in accordance with the corresponding network time;
request a subset of the first set of images of the first surveillance zone from the temporary memory storage area of the first imaging device and store the first set of images in the one or more memory storage areas of the control computing device.

13. The system of claim 12 further comprising a second imaging device configured to
capture a second set of images of a second surveillance zone, wherein the first surveillance zone is within the second surveillance zone;
time stamp the second set of captured images respectively in accordance with corresponding the network time; and
store the second set of captured images in a temporary memory storage area of the second imaging device.

14. The system of claim 13, wherein the one or more processors of the control computing device are further configured to request a subset of the second set of images of the second surveillance zone from the temporary memory storage area of the second imaging device.

15. The system of claim 14, wherein the one or more processors of the control computing device are further configured to store the subset of the first set of images of the first surveillance zone and the subset of the second set of images of the second surveillance zone.

16. The system of claim 12, wherein the first and second imaging devices are further configured to allow remote access via a network.

17. The system of claim 12, wherein the temporary memory storage areas of the first and second imaging devices comprise circular buffers.

18. The system of claim 12, wherein the first set of images of the first surveillance zone comprise narrow angle images.

19. The system of claim 12, wherein the first set of images of the first surveillance zone comprise wide angle images.

20. The system of claim 12, wherein the network time is established by synchronizing the first imaging device, the second imaging device, and the control computing device via a network time protocol (NTP).

21. The system of claim 12, wherein the one or more processors of the control computing device are further configured to generate an evidence package comprising at least a portion of the first and second sets of images.
